(19) United States
(12) Patent Application Publication
(10) Pub. No.: US 2024/0131957 A1
(43) Pub. Date: Apr. 25, 2024

(54) Wireless Communication System for Rechargeable Batteries

(71) Applicant: Lion Power, LLC, Greenville, SC (US)

(72) Inventors: Ryan Watts, Greenville, SC (US); Michael Walker, Greenville, SC (US); Timothy McCartney, Greenville, SC (US); John Ward, Greenville, SC (US)

(21) Appl. No.: 18/489,447

(22) Filed: Oct. 17, 2023

Related U.S. Application Data
(60) Provisional application No. 63/417,428, filed on Oct. 19, 2022.
(60) Provisional application No. 63/422,170, filed on Nov. 3, 2022.
(60) Provisional application No. 63/422,158, filed on Nov. 3, 2022.
(60) Provisional application No. 63/417,418, filed on Oct. 19, 2022.

(51) Int. Cl. B60L 53/80; B60L 53/66; H02J 7/00

(52) U.S. Cl. CPC B60L 53/80; B60L 53/66; H02J 7/0044; H04B 5/0037

(57) ABSTRACT

A wireless communication system for batteries removably mountable in local use vehicles and chargeable in a charging repository includes a plurality of batteries, each battery having a housing; a first wireless communication device attached to an outer surface of the housing for receiving and transmitting data; and electrical contacts attached to the housing for selectively providing power to or from the battery. A plurality of second wireless communication devices is mountable to either a one of the local use vehicles or to a location in the charging repository for communication with one of the first wireless communication devices when in an adjacent communication orientation. The first wireless communication devices and the second wireless communication devices communicate, potentially but not necessarily via an NFC protocol, only when in an adjacent communication orientation, so that one of the first wireless communication devices on a given one of the batteries can communicate with only one of the second wireless communication devices in the adjacent communication orientation without interference from others second wireless communication devices.

### CROSS-REFERENCE TO RELATED APPLICATIONS

This application claims benefit to U.S. Provisional Patent Application Nos. 63/417,418 and 63/417,428, having a filing date of Oct. 19, 2022; 63/422,158 and 63/422,170, having a filing date of Nov. 3, 2022, all of which are incorporated in its entirety by reference herein.

### TECHNICAL FIELD

The present disclosure relates generally to wireless communication systems for rechargeable batteries for powering vehicles.

### BACKGROUND

Local use vehicles such as forklifts, golf carts, shuttles, and others are in use in many locations, such as factories, warehouses, golf courses, parks, campuses, etc. Conventionally, such vehicles were powered by a combustible fuel such as gasoline, diesel, liquid propane, compressed natural gas, etc., although use of electric (battery-powered) vehicles has become more common in recent years. Typically, to charge batteries for such electric vehicles, the user drives the vehicle to a charging location where a power cord or other connector is available to connect the vehicle's battery to a source of power. Once connected, the power source recharges the battery, usually over a period of time measured in hours (e.g., 4-8 hours for a conventional forklift, golf cart, or automobile). After charging is complete, the vehicle can be driven away for further use. If the vehicle is a robotic shuttle such as an Automatic Guided Vehicle (AGV) in a so-called Dark Warehouse or other location, the vehicle's sensors and controls work in concert with the system's sensors and controls to drive the vehicle on its working route and to and from the charging location.

Where a site owner or manager of a location has a fleet of such electric vehicles on the site, managing use and charging can be logistically problematic. Vehicles are necessarily out of service during charging. Therefore, depending on location or operational requirements, a need may exist to have systemwide down time for recharging.

For example, all vehicles may be recharged overnight, if the location is not in service overnight. Such a protocol may work for example for a golf course's golf carts which only are used during daylight hours, but not for a factory or warehouse with vehicles needed in different, longer, less-predictable, or round-the-clock hours of operation. Sometimes, “opportunity charging” can be done, wherein vehicle batteries are partially charged or topped off during shorter breaks or shift downtime, but such charging is insufficient for overall system charging needs.

Therefore, in many locations, a surplus of vehicles is obtained, beyond the number needed in a time of peak use, to account for a portion of the vehicles being recharged at any given time. For example, depending on vehicle usage, a warehouse facility could need a surplus of 30 percent or more extra vehicles to ensure sufficient vehicles are charged and ready for use. Both pausing operation and purchasing excess vehicles to account for charging can cause logistical management of vehicles, employees, and the locations in general to be more complicated, and can incur various added costs. Having one or more dedicated areas in a facility for many vehicles to sit while charging also requires a large amount of space, essentially adding a “charging parking lot” to a site design.

In some locations, discharged batteries are manually removed and replaced by workers in dedicated areas in a facility. Such locations also require extra space and manpower, and the process can be very dangerous, time consuming, and costly. Further, removing and replacing heavy batteries having precise electrical (power) and communication (data) connectors makes installation and removal to and from vehicles or charging locations complicated, as well as increasing the risk of damage to the connectors due to inattention or imprecise movement.

Accordingly, improvements would be welcome in at least one of the operation and charging of local use battery-powered vehicles, vehicle and/or battery design, charger design, control systems, charging system automation, and footprint reduction, and battery communication systems, and the like addressing one or more of the above drawbacks of existing systems, and/or providing one or more additional benefits.

### SUMMARY

According to certain aspects of the disclosure, a wireless communication system is disclosed for rechargeable batteries for local use vehicles, the system including, for example, a charging repository; a plurality of batteries configured to be recharged in the charging repository and to power the local use vehicles; each battery including a first wireless communication device for receiving and transmitting data and electrical contacts for charging the battery or powering one of the local use vehicles; a plurality of second wireless communication devices, at least one of the second wireless communication devices attached to each of the local use vehicles for receiving and transmitting data when one of the batteries is inserted into the local use vehicle to power the local use vehicle via contact with the electrical contacts on the battery, at least one of the second wireless communication devices attached to the charging repository for receiving and transmitting data when one of the batteries is inserted into the charging repository for charging the battery via contact with the electrical contacts on the battery. Various options and modifications are possible.

For example, the first wireless communication devices and the second wireless communication devices may communicate via an NFC protocol, which may include half-duplex communication, and the NFC protocol may include distribution of embedded firmware updates and data transfer of historical data.

The second wireless communication devices may each include a battery interface assembly with a mount, an NFC transceiver attached to the mount in a first predetermined location, and electrical contacts attached to the mount in second predetermined locations, wherein the battery interface assembly is configured for wireless communication and electrical contact with a battery either in one of the local use vehicles or in the charging repository. The first wireless communication devices may also include an NFC transceiver attached to the battery in a position corresponding to the first predetermined position so as to allow NFC communication with the second wireless communication devices when located either in one of the local use vehicles or in the charging repository. The battery interface assembly may be configured for retrofit into local use vehicles and/or for attachment to a rack in the charging repository. The battery interface assembly may include an auxiliary battery for powering the second wireless communication device, and/or each battery may also include an auxiliary battery for powering the first wireless communication device.

According to other aspects of the disclosure, a wireless communication system is disclosed for batteries removably mountable in local use vehicles and chargeable in a charging repository, the system including, for example, a plurality of batteries, each battery having: a housing; a first wireless communication device attached to an outer surface of the housing for receiving and transmitting data; and electrical contacts attached to the housing for selectively providing power to or from the battery. A plurality of second wireless communication devices are mountable to either a one of the local use vehicles or to a location in the charging repository for communication with one of the first wireless communication devices when in an adjacent orientation. The first wireless communication devices and the second wireless communication devices communicate only when in an adjacent communication orientation, so that one of the first wireless communication devices on a given one of the batteries can communicate with only one of the second wireless communication devices in the adjacent communication orientation without interference from others second wireless communication devices. Again, various options and modifications are possible.

For example, the communication may be by NFC protocol including half-duplex communication. The second wireless communication devices may each include a battery interface assembly with a mount, an NFC transceiver attached to the mount in a first predetermined location, and electrical contacts attached to the mount in second predetermined locations, wherein the battery interface assembly is configured for wireless communication and electrical contact with a battery either in one of the local use vehicles or in the charging repository. The battery interface assembly may be configured for retrofit into local use vehicles and/or configured so that a plurality of the battery interface assemblies may be attached to a rack in the charging repository.

The battery interface assembly may include an auxiliary battery for powering the second wireless communication device, and/or each housing of each battery may include an auxiliary battery for powering the first wireless communication device. The NFC protocol may include distribution of embedded firmware updates and data transfer of historical data and real time battery status information.

### BRIEF DESCRIPTION OF THE DRAWINGS

More details of the present disclosure are set forth in the drawings.

FIG. 1 is a generalized isometric view of aspects of a system for charging batteries of a local use vehicle in a charging repository with at least one rack for holding and/or charging batteries and a robotic device for moving batteries.

FIG. 2 is an isometric view of one charging rack within the repository.

FIG. 3 is an isometric view of a robotic device contacting a battery in a local use vehicle.

FIG. 4 is an isometric view as in FIG. 3, with the robotic device holding a battery outside of the local use vehicle.

FIG. 5 is an isometric view of a battery assembly including a battery in a housing.

FIG. 6 is a view as in FIG. 5, with some outer housing walls removed.

FIG. 7 is an isometric front view of a battery removed from the housing.

FIG. 8 is an isometric rear view of the battery of FIG. 7.

FIG. 9 is a partial diagrammatic side view of the battery of FIG. 7 in contact with a cradle.

FIG. 10 is an isometric front view of the battery charging and communication assembly (cradle) that may be located in the local use vehicle or the rack.

FIG. 11 is a schematic diagram showing features and functions of one example of a battery and cradle suitable for use with the system and devices above.

### DETAILED DESCRIPTION

Detailed reference will now be made to the drawings in which examples embodying the present disclosure are shown. The detailed description uses numeral and letter designations to refer to features in the drawings. Like or similar designations in the drawings and description have been used to refer to like or similar parts of the disclosure.

The drawings and detailed description provide a full and enabling description of the disclosure and the manner and process of making and using it. Each embodiment is provided by way of explanation of the subject matter not limitation thereof. In fact, it will be apparent to those skilled in the art that various modifications and variations may be made to the disclosed subject matter without departing from the scope or spirit of the disclosure. For instance, features illustrated or described as part of one embodiment may be used with another embodiment to yield a still further embodiment.

In general, the figures below disclose one embodiment of a system and method of using removable/rechargeable batteries, chargers, and vehicles, in which communication between a battery containing an onboard Battery Monitoring System (BMS) and a host device (either the charger or the vehicle). Near-Field Communication (NFC) technology is used to establish a wireless data link between the battery and the host device when the two devices are in close proximity (i.e., in an adjacent communication orientation). By using the existing logical link control protocol (LLCP) on top of the NFC wireless link, an IP-based connection may be established to allow for real-time or pseudo-real time data transfer of battery status information, which may be used to control the charging and discharging of the battery.

One benefit of such as system is that, as NFC technology only operates when two devices are in close proximity, a system of multiple batteries, chargers (i.e., multiple charging bays in a charging repository such as a rack or multiple adjacent racks), and vehicles can all operate simultaneously even when located in the same area. Use of wireless communication technologies (Bluetooth, 802.11, 5 GHz, etc.) in such crowded situations would lead to bandwidth issues, identification, issues, etc.

According to certain aspects of the disclosure, each battery, charging device, and vehicle may include a controller including a microcontroller connected to an NFC ASIC and antenna. These NFC controllers are coupled the battery and its BMS with its controller, the vehicle interface controller, and the charging repository interface controller. The NFC controllers are connected to the respective device's controllers via whichever physical communication interface the device utilizes. Such connections may be, for example, serial, CAN, Ethernet, etc. The NFC controller can translate information from the device and send it over the NFC link to the charger or vehicle, and can also receive information from the charger or vehicle via the NFC link and translate to the device. By locating the NFC antenna of each charging bay/vehicle and the battery in corresponding locations relative to each other, an NFC link can be easily established when a battery is located in a charging bay or in a vehicle. Since NFC technology can only detect another antenna that is in close proximity, each battery and device can detect and initiate communication only with the desired pairings (i.e., devices in an adjacent communication orientation).

Other functions made possible by use of the NFC technology in the disclosed system and method include the ability of chargers/vehicles and batteries being able to wake the controllers from a low power sleep mode by using an interrupt function on the NFC controllers. Also, the systems can be programmed to “ferry” data from one device (to or from charger and vehicle) to another by using the battery as the intermediary carrier without relying on more expensive wireless technology for uplinks to the software repository. Thus, information such as vehicle use and performance data, fault codes, firmware information and updates, etc., may be uploaded to or from a central server when a battery is returned to the charging bay.

It should be understood that NFC equipment can be employed without employing NFC protocol to transmit data. Thus, inductively coupled short range communication, whether using NFC equipment and/or NFC protocol, is within the scope of the present disclosure.

Thus, use of NFC technology in such systems and methods has particular applicability to locations where the replacement of rechargeable batteries in local use vehicles is a frequent occurrence, wherein a physically connected data communication link would be failure prone, and wherein the use of other wireless technologies could be problematic due to RF spectrum crowding and interference.

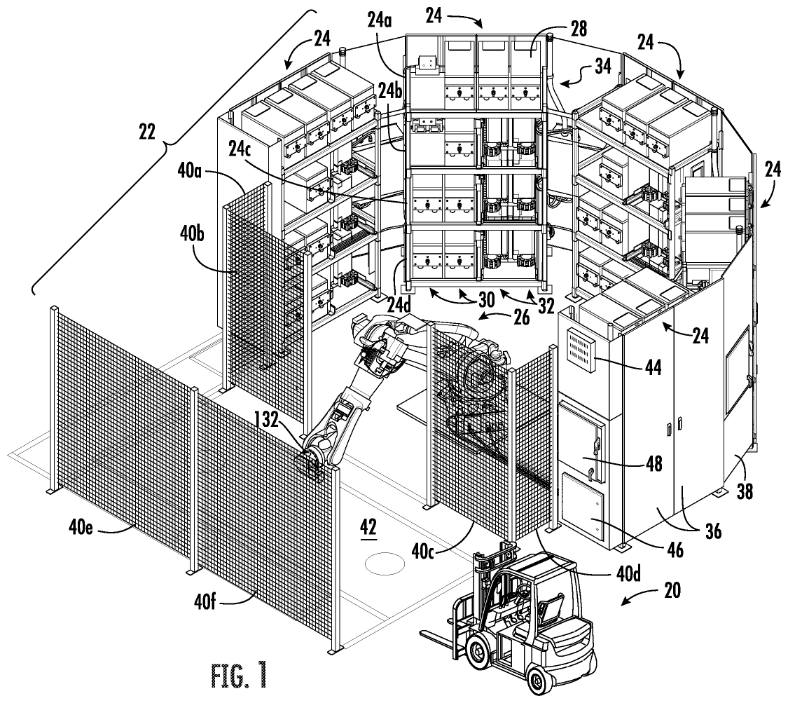

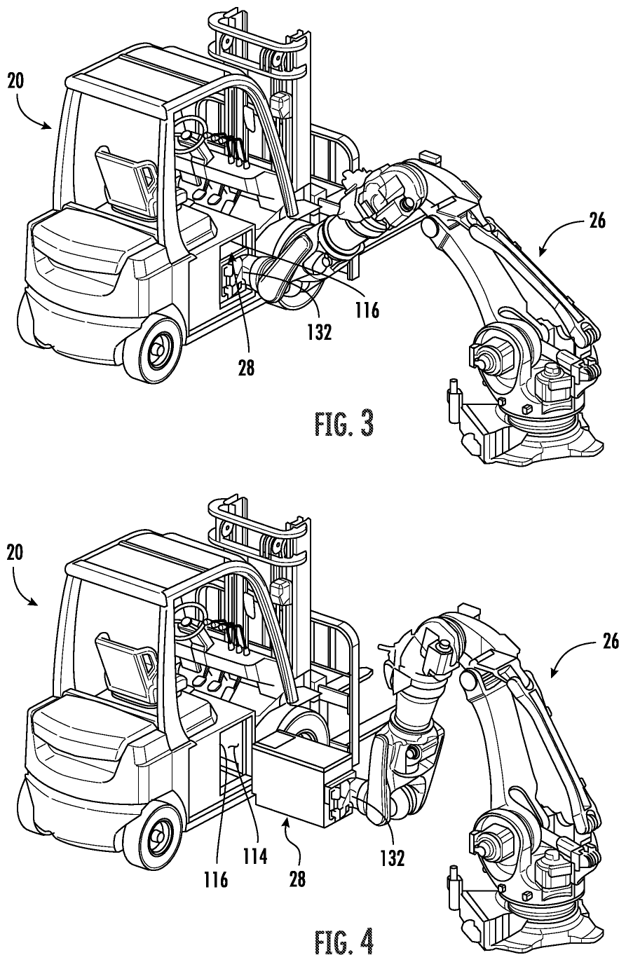

FIGS. 1-4 generally illustrate non-limiting examples of devices, systems, protocols, and methods for selectively charging batteries for a fleet of local use vehicles according to the present disclosure. The systems and methods employ charging a subgroup of batteries within an inventory of batteries, with a goal of having a sufficient number of sufficiently charged batteries (e.g., batteries charged at least to a charge threshold at which a battery has a charge level high enough to permit the battery to power one of the vehicles in a duty cycle) at the ready when need for replacement arises. Batteries are recharged in a charging repository, which may take the form of a rack, shelving unit, or the like. The repository may include several racks arranged side by side linearly or curvedly. Discharged batteries can be removed from the local use vehicles and placed in the repository for charging. Sufficiently charged batteries can be removed from the repository and inserted into the local use vehicles. Robotics can be employed to move the potentially heavy and large batteries safely and reliably between the vehicles and the repository. An articulated industrial robot, for example, with an arm, an end effector, sensors, and a programmable and/or AI logic control may be employed for such purpose. The repository may be efficiently spaced around the robot, for example in an arc allowing the robot to efficiently access batteries within the multiple bays within the repository as well as within the vehicle for exchange therebetween. The robot may also move batteries between bays within the repository, for example between a charging bay and a storage bay.

Automated systems of battery removal and installation, managing battery recharging, and providing as-needed sufficiently-charged batteries to the fleet of vehicles are thus envisioned. Batteries can be charged according to one or more control protocols, for example, wherein managing the provision of sufficiently-charged batteries and the timing and cost of electricity usage for charging. Thus, if permitted by expected or noted usage of batteries, charging can be scheduled to occur as much as possible during times of cost-optimized (“off-peak”) energy pricing. While electricity cost savings are always laudable, having a sufficient supply or a buffered supply (an amount over expected need) can be prioritized over simply optimizing charge cost.

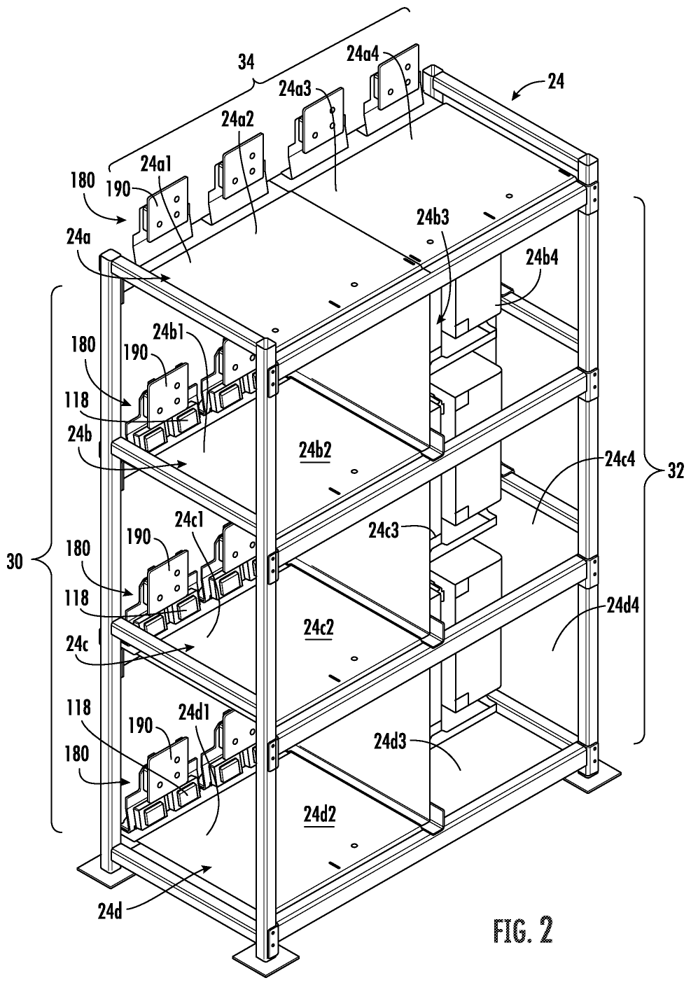

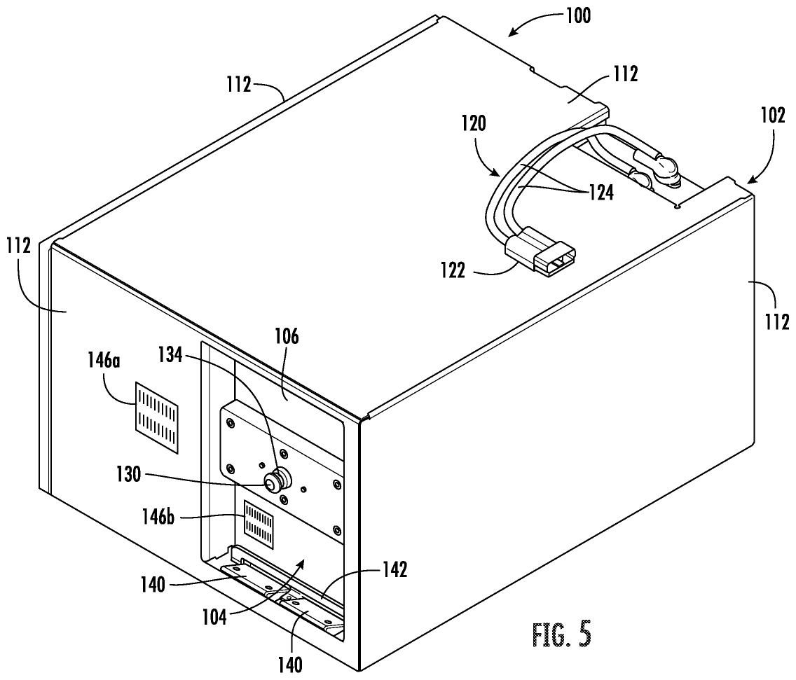

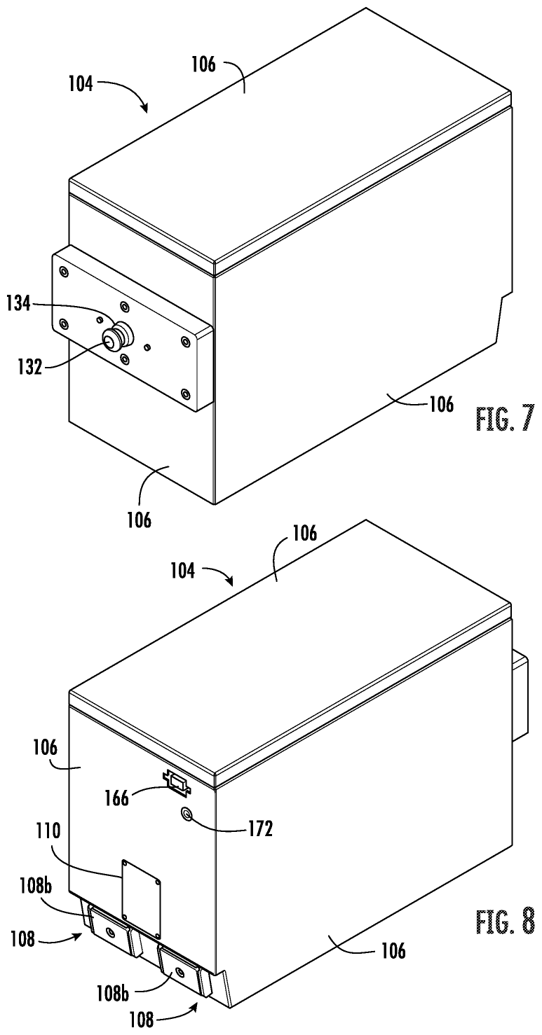

More particularly, FIGS. 1-4 depict one generalized example of a local use vehicle 20 and a charging repository 22. Repository 22 includes at least one rack 24 (see FIG. 2), with five of the racks being shown arranged in an arc in FIG. 1. Other number of racks, shapes, and arrangements are possible. More battery details and related components are shown in FIG. 5-16.

Repository 22 also includes a robotic device 26 such as a 6-axis robotic arm. The local use vehicle 20 is one vehicle within a fleet of such vehicles (identical or differentiated) used at the depicted location in which repository is located. Batteries 28 that power local use vehicles 20 are charged and stored in repository 22. More than one repository 22 could be used at a location, whether adjacent one another or distributed throughout the location. An inventory of batteries used in the system should be enough to power all of the vehicles within the fleet plus sufficient additional batteries being charged or stored in the repository so that sufficiently charged batteries are always available when vehicles need them.

As depicted, each rack 24 includes four levels 24a-d, and each level includes four bays 24a1-24d4 that may be configured to comprise a battery charging location 30, an electricity supply and control location 32, or a battery storage location 34. As shown, top level 24a of each rack 24 is configured for storage but not charging of batteries 28. Thus, bays 24a1-4 include communicating hardware to identify and monitor batteries 28 on level 24a, but not to charge the batteries. Levels 24b-d include two battery charging locations (bays 1 and 2 on each level), and two electrical supply and control locations (bays 3 and 4 on each level). Thus, in a rack 24 as shown, as many as six batteries may be charged simultaneously in levels 24b-d, and four batteries (partially or fully charged or uncharged) may be held and monitored in level 24a.

The above arrangement and uses of the bays and racks are but one example of many that could be employed.

Safety equipment and protocols may be used to protect the user or others during a battery exchange. Thus, protective devices 40a-f, such as screens, frames, rails, plastic or glass walls, etc., may be used to define a restricted-access battery exchange location 42. The user drives a vehicle 20 into location 42 and must exit the vehicle and location to commence battery exchange. Sensors, controls, indicators, and/or safety protocols may be employed to ensure that the user has driven a vehicle to a correct spot and orientation within exchange location 42, the user has exited the vehicle and the location, and no one has reentered the location before robotic battery exchange commences and/or completes. Thus, robotic battery exchange will not be started and can be halted if such safety protocol conditions are not met.

If desired, the user may exit location 42 and may be required to operate at least one active or passive input/output device 44 connected to a system controller 46 to indicate that the vehicle is ready for battery exchange and that the user is outside of exchange location 42. The input/output device may include buttons, dials, switches, touch screens, cameras, scanners, etc., for actively indicating readiness for battery exchange or providing identifying information as to the user, vehicle, etc. Sensors may be provided (such as a weight sensitive pad on which the user stands), an optical or ultrasonic position sensor for sensing a user location in a safe space, etc., to passively indicate user presence within a desired location outside of exchange location 42 during the exchange. Additional sensors, movable screens or shields, indicators, etc. (not shown), may be provided and connected to controller 46 (within a controller cabinet) to ensure the user or another person has not reentered exchange location before completion of the battery exchange. Safety systems may be connected directly to the robot controller to prevent motion of the robot unless the operating area is safe from accidental harm.

Power may be supplied by one or more main power sources 48 (within a power source cabinet). If desired, for example, 480V AC service may be provided via a cable to power source 48, which then distributes power to the various racks and charging or storage/monitoring stations. In some embodiments, AC power may be supplied to each rack, while other embodiments may have a single connection to the system with electrical distribution contained within the system. Wired or wireless connections may also be provided for communication of data between components of repository 22 and externally.

If the vehicle is a type not driven by an operator, such as an Automatic Guided Vehicle (AGV) in a so-called Dark Warehouse or other location, the vehicle's sensors and controls work in concert with the system's sensors and controls to cause the vehicle to drive to the exchange location 42 and to indicate that the system should then exchange the vehicle battery for one from the repository.

Robotic device 26 is configured to transfer batteries 28 back-and-forth between repository 24 and vehicles 20 and may also transfer batteries within bays of the rack(s) as needed. As depicted robotic device 26 is a conventional 6-axis Kawasaki BX300L with 2800 mm of reach, however the robotic device may be any device capable of manipulating and removing the battery from a vehicle and placing it into a rack system. Robotic device 26 has an end effector configured to engage, lift, and place batteries (which may have a mass of as much as 275 kg in some cases), and the batteries have mating connectors with engagement features. The end effector may also have one or more monovision or stereo vision optical sensors, laser distancers or readers, cameras, inertial monitoring units, etc., used for reading indicia on the vehicle and/or battery for identification purposes, and/or for aligning the robotic arm with the engagement features of the battery upon approach and lifting.

As depicted, vehicle 20 is a conventional, electrically-powered forklift vehicle, although modifications related to the inventive concepts disclosed herein may be employed, as discussed below. The vehicles within the fleet may or may not be identical to each other, and the batteries within the inventory used by the vehicle(s) may or may not be identical to each other. Thus, vehicles may be forklifts, golf carts, utility vehicles, trucks, construction equipment, service vehicles, delivery vehicles, automobiles, shuttles, automated warehouse carts, etc. Many aspects of the inventive concepts herein lend themselves to use in a location having a defined inside and/or outside perimeter, such as a factory, warehouse, storage yard, logistics center, port, office park, college or school campus, outdoor parks, etc., where multiple vehicles are used to move equipment, inventory, containers, raw materials, personnel, etc., throughout the location. However, aspects of the inventive concepts herein are also applicable to vehicles that drive off-site, for example delivery trucks that travel beyond an outer perimeter of a site on which the batteries are charged. The vehicles need not be completely powered by the batteries; instead, the vehicles may be for example plug-in or other hybrid vehicles with internal combustion or other propulsion systems in addition to the batteries.

Turning to further details regarding embodiments of the batteries, their housing assemblies, and related components, FIG. 5-8 show a first embodiment of a battery assembly 100 that could be used within a system as above, for example, to power a local use vehicle, and being movable between the vehicle and a charging receptacle via by an end effector of a robotic device. However, battery assemblies described below have separate utility and accordingly, need not be used with some or all of the aspects of the above system.

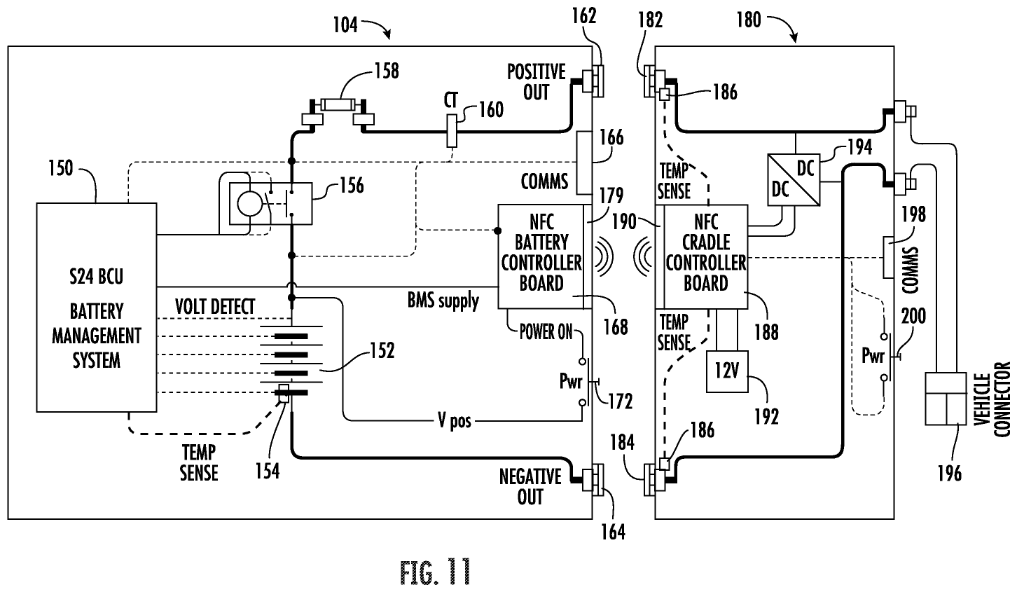

Battery assembly 100, as illustrated in FIGS. 5-8, includes a housing assembly 102 and a battery 104 within the housing assembly. Battery 104 may use lithium-ion, lithium-metal, or other battery chemistry. Battery 104 may have outer walls 106 partially or fully surrounding the battery. Battery 104 itself may include one or more connected cells (see FIG. 11) connected in parallel and/or series, as desired or needed for powering a particular vehicle in terms of desired parameters for wattage, voltage, current, charging aspects, etc., so as to provide a predetermined quantity of energy to power a local use vehicle. Other aspects of battery assembly 100 include electrical contacts 108 and a communication connection 110.

Housing assembly 102 is configured for mounting within a local use vehicle. If desired, housing assembly 102 may be sized and configured with walls, connectors, securing structure, and the like, so as to be usable to retrofit in place of an OEM lead-acid (or other) battery in a local use vehicle. Typically, the battery (cell) portion of such a lead-acid (or other) battery would have a larger form factor than that of a replacement lithium-ion or lithium metal battery. Thus, housing assembly 102 and its outer walls 112 may be configured to match the size and structural, connectional, and functional configuration of the OEM lead-acid (or other) battery. Battery 104 (including its outer walls 106) may then be located within outer walls 112 of housing assembly 102.

As discussed herein, battery 104 may be slid into and out of the vehicle (and the installed housing assembly 102) through use of a robot, as noted above, or by hand. Housing assembly 102 may thus define a battery compartment 114 within its outer walls 112, with an opening 116 through the outer walls 112 to allow such movement of battery 104. Opening 116 may remain open at all times, or may be closeable by a door, cover, etc., (not shown) if desired.

Electrical contacts and communication connections, described below, are provided between the battery and the vehicle and/or the charging repository. A substantially identical cradle can be used both in the vehicles and in the racks for such electrical and communication connection.

Thus, housing assembly 102 may further include first electrical contacts 118 for contacting the electrical contacts 108 of the battery 104 when the battery is in a fully-inserted position within the battery compartment 114, and second electrical contacts 120 for electrical connection to the local use vehicle 20 for powering the local use vehicle from the battery. Electrical contacts 108, 118 may be, for example, copper plates creating a bi-directional conduction path when in contact. Electrical contacts 120 may be within a plug 122 at the end of a cable 124 for connection to the vehicle.

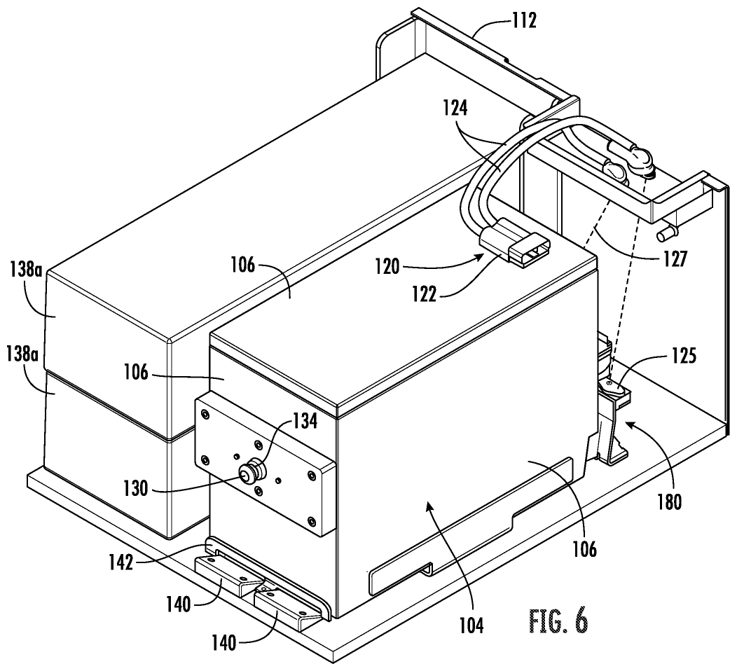

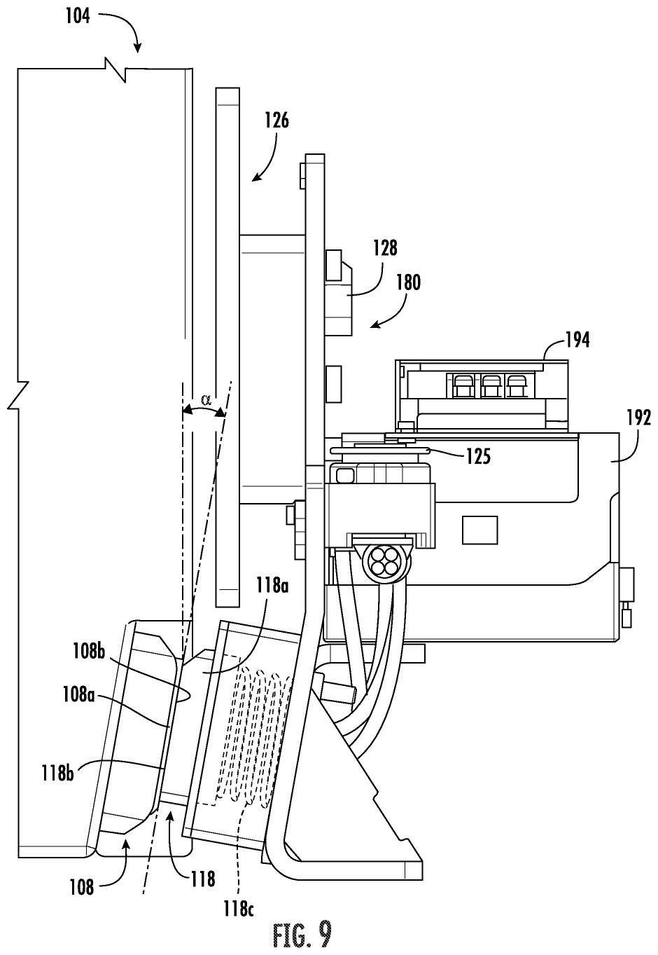

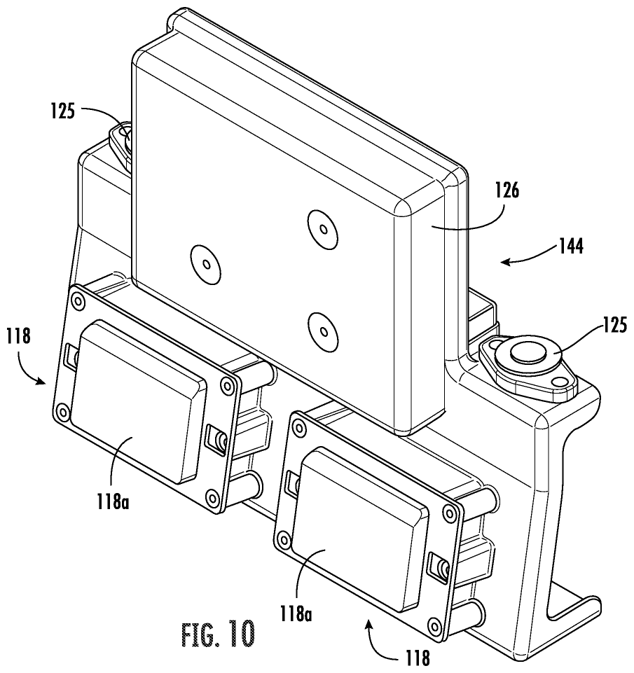

Housing assembly 102 further includes a first communication connection 126 for data communication with communication connection 110 of battery 104 when the battery is in a fully-inserted position within the battery compartment 114, and a second communication connection 128 for data communication with the local use vehicle 20. Second communication connection 128 may be a port into which a cable (not shown) is plugged. Communication connections 110,126 may be wireless and noncontact based, such as antennas for bi-directional NFC communication between the battery and housing assembly when the battery is inserted in the housing assembly. Close-proximity wireless communication provides a secure and reliable connection that does not require exact alignment and connection/disconnection steps, and avoids potential damage created thereby, when moving batteries from the vehicles to the racks and vice versa. Also, NFC communication provides benefits of avoiding frequency and bandwidth crowding where multiple batteries are being used in a location, particularly in a charging repository with many batteries. Plug 122 and cable 124 may also incorporate the wiring leading to second communication connection 128 to transmit (bi-directionally) data etc., between the battery and the vehicle using a single plug-in cable if desired. Wires within cable 124 may be attached directly or indirectly to terminals 125 (FIGS. 9 and 10), for example, as schematically illustrated by connections 127 in FIG. 6.

The battery may further include a grasping point 130 extending from one of the outer walls 106 of the battery adjacent the opening 106 in the housing assembly 102. Grasping point 106 may be of various designs, configured for complimentary use with the end effector 132 of the robotic device, with the dimensions and weight of the battery kept in mind. As illustrated, grasping point 130 is a generally cylindrical element with a groove 134 for receiving protrusions or other grasping structures in end effector 132, so that battery 104 may be grasped and moved securely by the end effector to thereby move the battery back and forth between the fully-inserted position in the housing assembly 102 (or in the vehicle directly if no housing assembly is required) and a removed position outside of the housing assembly via the opening 116 (again, in the housing assembly, or in the vehicle itself if no housing assembly is required).

If desired, electrical contacts 108 of the battery 104 and first electrical contacts of the housing assembly 118 each may have contact members 108a,118a, with contact surfaces 108b,118b for mutual contact oriented in a common plane 136 that is at an acute angle a relative to the vertical when the battery is in the fully-inserted position (see FIG. 9). Alternatively or additionally, each first electrical contact 118 of the housing assembly may include a spring member (e.g., compression spring 118c) for urging the contact member 118a in a direction toward a respective contact member 108a of battery 104. Such angled contact surfaces, and such spring-loaded contact, either separately or together, allow for a more reliable electrical connection when moving the large and massive battery using the robot than would be a vertical or horizontal contact surface without spring loading due to the wiping action provided by the relative motion during insertion. Such structures are also useful on a cradle assembly on rack 24 for similar reasons. Further, if desired, the spring loading could be reversed (placed on the battery) or used on both the battery and housing/rack cradle.

Battery assembly 100 may, if desired, include a ballast. Such may be useful, for example, where battery assembly 100 and/or battery 104 is replacing a heavier OEM battery (such as lead acid or other battery type), but may be employed in other applications as well. As shown in FIG. 6, ballast may include one or more ballast elements 138a, located within housing assembly 102 laterally adjacent battery 104. If a replacement as noted above, such ballast may have a mass related to a difference between a mass of battery 104 and housing assembly 102 and a mass of an alternate (OEM or other) energy source for powering the vehicle, the battery, the housing assembly, and the ballast being collectively configured as a retrofit of the alternate energy source. Alternatively, ballast elements may be differently located relative to the battery and housing assembly in general.

If desired, structures such as internal ribbing within housing assembly 102 or a ramp 140 adjacent opening 116 may be provided to help guide battery 104 in and out of housing assembly 102. A retaining structure may also be provided within housing assembly 102 or the vehicle to maintain battery 104 in place when inserted, so that when the vehicle moves, the battery and its contacts and connections remain in place. The retaining structure may include a fixed, movable, or removable gate 142 or other retention structure that holds battery 104 in place and in contact as desired.

Readable indicia may be located on one or more surfaces of housing assembly 102 or battery 104 (see indicia 146a, 146b) to identify any desired characteristics or positioning of the battery or housing assembly. The indicia could be words, machine readable codes such as barcodes, QR codes or the like, or positioning detection elements. One or more detectors, such as cameras, optical or acoustic sensors, laser distancers, etc., may be mounted on robotic device 26, such as on or near end effector 132 for detecting the readable indicia or a position of the battery or vehicle. Other detectors may be located on other parts of robotic device 26 on or adjacent charging repository 22 to assist with identification and robot positioning. Some of all of the indicia may be located near the grasping point 130, if desired.

With reference to FIG. 11, and in view of previous figures, various elements and connections between the battery assembly and the vehicle or charging rack connection/cradle, will be discussed. Generally speaking, the battery assembly includes an onboard battery monitoring system and should include at least one sensor, a controller, and an auxiliary battery, although many options and customizations are possible for particular applications. Also, it should be understood that battery 104 and cradle 180 may be located within a housing assembly 102 (not shown in FIG. 11 for clarity). Alternatively, Cradle assembly 180 may be located within the vehicle itself—apart from any housing assembly 102 that might be provided to house battery 104, is such housing assembly 1 is provided at all. Thus, in a simplified embodiment, a cradle could be fixed to the vehicle and the battery without an external housing such as 102 could be slid in and out of the vehicle for use/charging.

Within battery 104, the Battery Management System (BMS) controller 150 is used for battery management, and may be an S24 Bus Controller Unit (BCU). The BMS Controller may detect cell 152 voltages and may monitor temperatures via sensors 154 (one shown schematically) throughout the cell stack. Controller 150 thus tracks State of Health (SOH, i.e., estimated capacity) and State of Charge (SOC) of the cells 152, as well as monitoring current and terminal voltages.

A contactor/relay 156 may be used to open/complete the circuit of the battery cells. It is controlled by the BMS Controller 150. As a safety feature, it also can incorporate aux terminals to detect fused/welded state of the contactor, and thereby cause the controller to indicate a fault and respond as needed for the situation.

A fuse 158 may be included. If used for a forklift, it may be a conventional low-voltage, high current fuse for short circuit protection.

The battery stack 154 itself may comprise cells 152 such as high Ah capacity series/parallel array of connected battery cells providing an Ah rating of in the range of, for example, 100 Ah to 800 Ah. The cells may be prismatic or cylindrical, and the cells may have various chemistries such as Lithium Ion, Lithium NMC, LiFePO4, or other chemistries. The stack may be built in low voltage “modules” of a group of cells, with a welded, series-connection bulbar per group.

A current transducer 160, such as a Hall-effect current sensor, can be employed to detect and calculate State of Charge (SOC) or detect other conditions of the vehicle as needed by the system, which may be carried out in conjunction with the BMS Controller 150.

A positive terminal (Positive Out) 162 and a negative terminal (Negative Out) 164 are provided for electrical contact to the cradle in the vehicle or rack. Terminals 162,164 are conventional passthrough insulated/isolated terminals, and may include bolt-on copper plates for the conduction path from plate in the cradle to reduce contact resistance when connecting to the Battery Housing Terminals 182, 184.

Communication port 166 may be a plug connector for attachment to a cable and may contain for example, power/gnd, CAN communication, and a power switch signal to provide auxiliary functionality in the event the NFC battery controller 168 is not installed or unavailable. NFC battery controller board 168 controls the external communication interface to the cradle in the vehicle or rack via the NFC antenna 170, and controls onboard keep-alive power for the BMS 150. It is continuously powered by the lithium battery stack 152 terminal voltage (pre-contactor), and is able to cut its own power if necessary to limit vampire power load. It also stores data/fault codes from battery and connected devices for later upload via a telemetry system.

Power switch 172 may be a conventional contact-activated normally open switch, and may provide a “wake-up” signal for NFC board 168 to turn on active power to the BMS 150.

As stated above, the cradle assembly 180 shown is suitable for use in a vehicle, but a similar or identical cradle assembly may be employed in the racks. If desired, communication functionality but not charging functionality may be provided on certain rack cradle assemblies that are resident in storage locations (not charging locations), such as the top row in FIG. 2. Of course, communication and charging vs discharging would be different and in many ways reversed in the two locations. However, due to the modular and multipurpose configuration of the battery and its connectors/communication devices, many aspects of the cradle may be identical in both locations.

Cradle 180 includes positive terminal 182 and a negative terminal 184. Each terminal 182,184 may include spring-loaded, carbon-infused copper plates, with integrated temperature probes 186 to monitor interconnection temperatures using the NFC board 188 of the cradle 180. Terminals 182,184 are designed to provide a high-power connection between the battery 104 and battery housing 102 during use.

The NFC Cradle Controller Board 188 communicates with battery NFC device 168 via NFC antennas 190 and 170 to request the battery contactor be closed or opened, or may request cooling or heating of the battery based on environmental conditions. It also communicates with an attached vehicle (or rack) via CAN, serial, ethernet, or other physical electrical connection.

A small back-up battery 192, such as a 12V sealed Lead Acid battery with a 5 Ah capacity, or other battery as needed, can be used to power the NFC Cradle Controller board 188, or may be used as a “keep alive” power source for maintaining external, small loads on the vehicle when main lithium battery is removed.

A DC/DC converter 194 may provide a conversion of power from lithium terminal voltage (e.g., 36V or 48V) to a lower voltage to power the NFC Cradle Controller 188 and may recharge the 12V Sealed Lead Acid battery 192.

Vehicle connector 196 may comprise plug 122 at end of cable 124 to provide connection to the vehicle at the lithium battery cell voltage (e.g., 36V, or 48V, or another voltage). It may be an Anderson SB350 connection or other, as required by the vehicle manufacturer. Additionally, the connector may be omitted if the battery housing is permanently installed in the vehicle and a more secure connection is desired.

An optional communication connector 198 is a plugin port for receiving a cable to communicate with vehicle control systems and receive requests from the vehicle for power. It may also send de-rate requests to the vehicle based on battery operational requirements. If desired such communication function may be included within vehicle connector 196.

A conventional contact actuated power switch 200 may be employed to turn on the Cradle 180 if in “sleep” mode, and to enable communication and power consumption by the NFC board 188 to begin turning on the main battery. Switch 200 may used because the battery switch may be inaccessible while the battery is installed in the Battery Housing, or the cradle may turn off to conserve power if the vehicle is not consuming energy, or for some other reason.

It should be understood that the above description of the battery and cradle and their components are exemplary only, and many variations and modifications in structure and function can be employed. Thus, while preferred embodiments of the invention have been described above, it is to be understood that any and all equivalent realizations of the present invention are included within the scope and spirit thereof. Thus, the embodiments depicted are presented by way of example only and are not intended as limitations upon the present invention. Thus, while particular embodiments of the invention have been described and shown, it will be understood by those of ordinary skill in this art that the present invention is not limited thereto since many modifications can be made. Therefore, it is contemplated that any and all such embodiments are included in the present invention as may fall within the literal or equivalent scope of the appended claims.

We claim:

1. A wireless communication system for rechargeable batteries for local use vehicles, the system comprising:
a charging repository;
a plurality of batteries configured to be recharged in the charging repository and to power the local use vehicles;
each battery including a first wireless communication device for receiving and transmitting data and electrical contacts for charging the battery or powering one of the local use vehicles; and
a plurality of second wireless communication devices, at least one of the second wireless communication devices attached to each of the local use vehicles for receiving and transmitting data when one of the batteries is inserted into the local use vehicle to power the local use vehicle via contact with the electrical contacts on the battery, at least one of the second wireless communication devices attached to the charging repository for receiving and transmitting data when one of the batteries is inserted into the charging repository for charging the battery via contact with the electrical contacts on the battery.

2. The system of claim 1, wherein the first wireless communication devices and the second wireless communication devices communicate via an NFC protocol.

3. The system of claim 2, wherein the NFC protocol includes half-duplex communication.

4. The system of claim 2, wherein the NFC protocol includes distribution of embedded firmware updates and data transfer of historical data.

5. The system of claim 1, wherein the second wireless communication devices each include a battery interface assembly with a mount, an NFC transceiver attached to the mount in a first predetermined location, and electrical contacts attached to the mount in second predetermined locations, wherein the battery interface assembly is configured for wireless communication and electrical contact with a battery either in one of the local use vehicles or in the charging repository.

6. The system of claim 5, wherein the first wireless communication devices include an NFC transceiver attached to the battery in a position corresponding to the first predetermined position so as to allow NFC communication with the second wireless communication devices when located either in one of the local use vehicles or in the charging repository.

7. The system of claim 5, wherein the battery interface assembly is configured for retrofit into local use vehicles.

8. The system of claim 5, wherein the battery interface assembly is configured for attachment to a rack in the charging repository.

9. The system of claim 5, wherein the battery interface assembly includes an auxiliary battery for powering the second wireless communication device.

10. The system of claim 1, wherein each battery includes an auxiliary battery for powering the first wireless communication device.

11. A wireless communication system for batteries removably mountable in local use vehicles and chargeable in a charging repository, the system comprising:
a plurality of batteries, each battery having:
a housing;
a first wireless communication device attached to an outer surface of the housing for receiving and transmitting data; and
electrical contacts attached to the housing for selectively providing power to or from the battery; and
a plurality of second wireless communication devices, the second wireless communication devices mountable to either a one of the local use vehicles or to a location in the charging repository for communication with one of the first wireless communication devices when in an adjacent communication orientation;
wherein the first wireless communication devices and the second wireless communication devices communicate only when in an adjacent communication orientation, so that one of the first wireless communication devices on a battery can communicate with only one of the second wireless communication devices in the adjacent communication orientation without interference from others second wireless communication devices.

12. The system of claim 11, wherein the first wireless communication devices and the second wireless communication devices communicate via an NFC protocol including half-duplex communication.

13. The system of claim 11, wherein the second wireless communication devices each include a battery interface assembly with a mount, an NFC transceiver attached to the mount in a first predetermined location, and electrical contacts attached to the mount in second predetermined locations, wherein the battery interface assembly is configured for wireless communication and electrical contact with a battery either in one of the local use vehicles or in the charging repository.

14. The system of claim 13, wherein the battery interface assembly is configured for retrofit into local use vehicles.

15. The system of claim 13, wherein the battery interface assembly is configured so that a plurality of the battery interface assemblies may be attached to a rack in the charging repository.

16. The system of claim 13, wherein the battery interface assembly includes an auxiliary battery for powering the second wireless communication device.

17. The system of claim 11, wherein each housing of each battery includes an auxiliary battery for powering the first wireless communication device.

18. The system of claim 11, wherein the NFC protocol includes distribution of embedded firmware updates and data transfer of historical data and real time battery status information.
